(19) United States
(12) Patent Application Publication
(10) Pub. No.: US 2024/0191012 A1
(43) Pub. Date: Jun. 13, 2024

(54) Method of Making a Fluoropolymer Dispersion Having a Low Amount of Perfluoroalkanoic Acids or Salts Thereof and the Fluoropolymer Comprises a Low Ionic End Group Ratio

(71) Applicant: 3M INNOVATIVE PROPERTIES COMPANY, St. Paul, MN (US)

(72) Inventors: Tatsuo Fukushi, Woodbury, MN (US); Miguel A. Guerra, Woodbury, MN (US); Klaus Hintzer, Kastl (DE); Michael H. Mitchell, Edina, MN (US); Justin T. Roop, Madison, AL (US); Steffen Vowinkel, Mühldorf am Inn (DE)

(21) Appl. No.: 18/553,738

(22) PCT Filed: May 31, 2022
(86) PCT No.: PCT/IB2022/055078

§ 371 Date: Oct. 3, 2023

Related U.S. Application Data
(60) Provisional application No. 63/202,437, filed on Jun. 11, 2021.

(51) Int. Cl. C08F 214/26; C08F 2/26; C08F 2/38; C08F 216/14; C08L 27/18

(52) U.S. Cl. CPC C08F 214/262; C08F 2/26; C08F 2/38; C08F 216/1408; C08L 27/18; C08F 2800/20; C08L 2201/50

(57) ABSTRACT

Described herein is a method of making a fluoropolymer, the method comprising: providing an aqueous mixture comprising a fluorinated monomer, and an initiator; polymerizing the aqueous mixture under free radical conditions; and adding perfluoromethyl iodide during the polymerization to provide an aqueous dispersion of the fluoropolymer, wherein the amount of perfluorooctanoic acid or salt thereof in the aqueous dispersion of the fluoropolymer is not more than 25 nanograms per gram of the fluoropolymer.

### TECHNICAL FIELD

Described herein is a method of making a fluoropolymer dispersion, wherein the fluoropolymer dispersion has a low amount of perfluoroalkanoic acids or salts thereof and the resulting fluoropolymer has a low ionic end group ratio.

### SUMMARY

There is a desire to identify fluoropolymer dispersions, wherein the fluoropolymer has a low ionic end group ratio, and the fluoropolymer dispersion as polymerized does not suffer from high levels of perfluoroalkyl monoacids (such as perfluorooctanoic acid) or salts thereof.

In one aspect, a method of making a fluoropolymer is described. The method comprises:
providing an aqueous mixture comprising a fluorinated monomer, and an initiator;
polymerizing the aqueous mixture under free radical conditions; and
adding perfluoromethyl iodide during the polymerization to provide an aqueous dispersion of the fluoropolymer,
wherein the amount of perfluorooctanoic acid or salt thereof in the aqueous dispersion of the fluoropolymer is not more than 25 nanograms per gram of the fluoropolymer.

In one aspect a fluoropolymer is described. The fluoropolymer is made by providing an aqueous mixture comprising a fluorinated monomer, and an initiator; polymerizing the aqueous mixture under free radical conditions; and adding perfluoromethyl iodide during the polymerization to provide an aqueous dispersion of the fluoropolymer.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term
“a”, “an”, and “the” are used interchangeably and mean one or more;
“Alkyl group” and the prefix “alk-” are inclusive of both straight chain and branched chain groups and of cyclic groups having up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms;
“Alkylene” is the multivalent (e.g., divalent or trivalent) form of the “alkyl” groups defined above;
“and/or” is used to indicate one or both stated cases may occur, for example A and/or B includes, (A and B) and (A or B);
“backbone” refers to the main continuous chain of the polymer;
“cross-linking” refers to connecting two pre-formed polymer chains using chemical bonds or chemical groups;
“cure site” refers to functional groups, which may participate in cross-linking;
“interpolymerized” refers to monomers that are polymerized together to form a polymer backbone;
“monomer” is a molecule which can undergo polymerization which then form part of the essential structure of a polymer;
“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms; and
“polymer” refers to a macrostructure having a number average molecular weight (Mn) of at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to cause premature gelling of the polymer.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

As used herein “as polymerized” refers to the polymerized product before any work-up or post-processing steps, particularly those known to be useful for removing perfluoroalkyl monoacids, e.g., anion exchange, treatment with organic liquid.

Fluoropolymers are used in a variety of applications as they have several desirable properties such as heat resistance, chemical resistance, weatherability, UV-stability, and optical properties including transparency and low refractive index. A wide variety of perfluorinated and partially fluorinated polymers are available, including both fluorothermoplastics and fluoroelastomers.

It is known that minimizing ionic end groups is important in eliminating weak points of a fluoropolymer. Various methods have been reported to reduce ionic and polar end groups in certain fluoropolymers. Some methods are directed toward the polymerization, for example, use of fluoroalkyl sulfinic acid or sulfinates and an oxidizing agent to initiate polymerization: (see, e.g., U.S. Pat. No. 5,285,022 (Grootaert), U.S. Pat. No. 8,604,137 (Grootaert et al.); and U.S. Pat. No. 5,639,837 (Farnham et al.), while other methods are directed to post polymerization processing, for example, post-fluorination, or heat treatment (see, e.g., U.S. Pat. No. 6,211,319 (Schmiegel)).

In addition to the desire to have polymers with low ionic end group ratios, it is also desirable to have sustainable processes, which minimize the generation of perfluorinated alkanoic acids, such as perfluorooctanoic acid, which are being phased out of manufacturing for a variety of reasons.

It has been discovered that even without using perfluorinated alkyl carboxylic acids or sulfonic acids or salts thereof, an as polymerized fluoropolymer dispersion may comprise such groups. Therefore, the present disclosure is directed toward a method of producing a fluoropolymer having low ionic end groups, while also minimizing the amount of perfluoroalkyl monoacids and salts thereof in the as polymerized dispersion.

The method of the present disclosure is directed toward aqueous polymerization techniques involving the polymerization of fluorinated monomers using a free radical initiator to initiate the polymerization and perfluoromethyl iodide.

In one embodiment, an aqueous mixture comprising a fluorinated monomer and an initiator is used. The fluorinated monomers of the present disclosure include perfluorinated and partially fluorinated monomers.

Exemplary perfluorinated monomers include perfluoroolefins (e.g., tetrafluoroethylene (TFE) and hexafluoropropylene (HFP), chlorotrifluoroethylene (CTFE), and any perfluoroolefin of the formula CF₂=CF−R_{f}, where R_{f} is fluorine or a perfluoroalkyl of 1 to 8, in some embodiments 1 to 3, carbon atoms), and perfluoro ethers.

Exemplary perfluoro ether monomers are of Formula (I)

CF₂═CF(CF₂)_{b}O(R_{f}_{^{−}}O)ₙ(R_{f}_{^{−}}O)ₘR_{f3} (I)

where R_{f}_{^{−}} and R_{f}_{^{−}} are independently linear, branched, or cyclic perfluoroalkylene radical groups comprising 2, 3, 4, 5, or 6 carbon atoms, m and n are independently an integer selected from 0, 1, 2, 3, 4, 5, 6, 7, 8, 9, and 10, and R_{f3} is a perfluoroalkyl group comprising 1, 2, 3, 4, 5, or 6 carbon atoms. Exemplary perfluoroalkyl vinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), CF₂—CF(OCF₂CF(CF₃))₂—O—C₃F₇ (PPVE-3), CF₂—CF(OCF₂CF(CF₃))₃—O—C₃F₇ (PPVE-4), perfluoro-3-methoxy-n-propylvinyl ether, perfluoro-2-methoxy-ethylvinyl ether, perfluoro-methoxy-methylvinylether (CF₃—O—CF₂—O—CF═CF₂), CF₃—(CF₂)₂—O—CF(CF₃)—CF₂—O—CF(CF₃)—CF₂—O—CF—CF₂, CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂OCF₂CF₃, CF₂—CFOCF₂CF₂CF₂OCF₂CF₃, CF₂—CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂—CFOCF₂CF₂OCF₂CF₂CF₂OCF₃, CF₂—CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃, CF₂—CFOCF₂CF₂OCF₂CF₂CF₃, and CF₂═CFOCF₂CF₂OCF₂CF₂OCF₂CF₂CF₃.

Exemplary perfluoroalkyl allyl ether monomers include: perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, CF₃—(CF₂)₂—O—CF(CF₃)—CF₂—O—CF(CF₃)—CF₂—O—CF₂CF═CF₂, F₂═CFCF₂OCF₂CF₂OCF₃, CF₂═CFCF₂OCF₂CF₂CF₂OCF₃, CF₂═CFCF₂OCF₂OCF₃, CF₂═CFCF₂OCF₂OCF₂CF₃, CF₂—CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂—CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂—CFCF₂OCF₂CF₂(OCF₂)₃OCF₃, CF₂—CFCF₂OCF₂CF₂(OCF₂)₄OCF₃, CF₂—CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, CF₂═CFCF₂OCF₂CF(CF₃)—O—C₃F₇, and CF₂═CFCF₂(OCF₂CF(CF₃))₂—O—C₃F₇. Many of these perfluoroalkoxyalkyl allyl ethers can be prepared, for example, according to the methods described in U.S. Pat. No. 4,349,650 (Krespan).

Exemplary partially fluorinated monomers include vinyl fluoride (VF), vinylidene fluoride (VDF), pentafluoropropylene, trifluoroethylene, or an olefin in which less than half or less than one-fourth of the hydrogen atoms are replaced with fluorine.

In some embodiments, halogen- or hydrogen-containing olefins useful as monomers in the method of the present disclosure include those of the formula CX₂═CX—R, wherein each X is independently hydrogen, fluorine, or chlorine atom and R is hydrogen, fluorine, or a C₁-C₁₂, in some embodiments C₁-C₃, alkyl, with the proviso that not all X and R groups are fluorine groups.

In some embodiments, small amounts of other copolymerizable monomers, which may or may not contain fluorine substitution, e.g. ethylene, propylene, butylene and the like can be used. Generally, these additional monomers would be used at less than 25 mole percent of the fluoropolymer, preferably less than 10 mole percent, and even less than 3 mole percent.

In one embodiment, cure-site monomers are used to incorporated cure sites into the resulting fluorinated polymer to facilitate cross-linking in appropriate cure systems. The cure sites comprise at least one of iodine, bromine, and/or nitrile.

Exemplary cure-site monomers include those of the formula CX₂═CX(Z), wherein each X is independently H or F, and Z is I, Br, or R_{f}—Z, wherein Z is I or Br and R_{f} is a perfluorinated or partially perfluorinated alkylene group optionally containing O atoms. In addition, non-fluorinated bromo- or iodo-substituted olefins, e.g., vinyl iodide and allyl iodide, can be used. In some embodiments, the cure-site monomer is CH₂═CHI, CF₂═CHI, CF₂═CFI, CH₂═CHCH₂I, CF₂═CFCF₂I, ICF₂CF₂CF₂CF₂I, CH₂═CHCF₂CF₂I, CF₂═CFCH₂CH₂I, CF₂—CFCF₂CF₂I, CH₂—CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂—CFOCF₂CF₂Br, CF₂═CFCI, I—CF₂—CF₂CF₂—O—CF═CF₂, I—CF₂—CF₂CF₂—O—CF₂CF═CF₂, I—CF₂—CF₂—O—CF₂—CF═CF₂, I—CF(CF₃)—CF₂—O—CF—CF₂, I—CF(CF₃)—CF₂—O—CF₂—CF—CF₂, I—CF₂—CF₂—O—CF(CF₃)—CF₂—O—CF═CF₂, I—CF₂—CF₂—O—CF(CF₃)—CF₂—O—CF₂—CF═CF₂, I—CF₂—CF₂—(O—(CF(CF₃)—CF₂)₂—O—CF═CF₂, I—CF₂—CF₂—(O—(CF(CF₃)—CF₂)₂—O—CF₂—CF═CF₂, Br—CF₂—CF₂—O—CF₂—CF—CF₂, Br—CF(CF₃)—CF₂—O—CF═CF₂, I—CF₂—CF₂—CF₂−O—CF(CF₃)—CF₂—O—CF═CF₂, I—CF₂—CF₂—CF₂—O—CF(CF₃)—CF₂—O—CF₂—CF—CF₂, I—CF₂—CF₂—CF₂—(O—(CF(CF₃)—CF₂)₂—O—CF═CF₂, I—CF₂—CF₂—CF₂—O—(CF(CF₃)—CF₂—O)₂—CF₂—CF═CF₂, Br—CF₂—CF₂—CF₂—O—CF═CF₂, Br—CF₂—CF₂—CF₂—O—CF₂—CF—CF₂, I—CF₂—CF₂—O—(CF₂)₂—O—CF═CF₂, I—CF₂—CF₂—O—(CF₂)₃—O—CF—CF₂, I—CF₂—CF₂—O—(CF₂)₄—O—CF═CF₂, I—CF₂—CF₂—O—(CF₂)₂—O—CF₂—CF═CF₂, I—CF₂—CF₂—O—(CF₂)₃—O—CF₂—CF═CF₂, I—CF₂—CF₂—O—(CF₂)₂—O—CF(CF₃)CF₂—O—CF₂—CF₂, I—CF₂—CF₂—O—(CF₂)₂—O—CF(CF₃)CF₂—O—CF₂—CF₂═CF₂, Br—CF₂—CF₂—O—(CF₂)₂—O—CF═CF₂. Br—CF₂—CF₂—O—(CF₂)₃—O—CF═CF₂, Br—CF₂—CF₂—O—(CF₂)₄—O—CF═CF₂, and Br—CF₂—CF₂—O—(CF₂)₂—O—CF₂—CF═CF₂, CF₂═CFCl, CF₂═CFCF₂Cl, or a mixture thereof.

Exemplary nitrile-containing cure-site monomers include nitrile-containing fluorinated olefins and nitrile-containing fluorinated vinyl ethers, for example, CF₂—CFO(CF₂)_{L}CN, CF₂═CFO(CF₂)ᵤOCF(CF₃)CN, CF₂═CFO[CF₂CF(CF₃)O]_{q}(CF₂O)_{y}CF(CF₃)CN, or CF₂═CF[OCF₂CF(CF₃)]ᵣO(CF₂)ₜCN, wherein L is in a range from 2 to 12; u is in a range from 2 to 6; q is in a range from 0 to 4; y is in a range from 0 to 6; r is in a range from 1 to 2; and t is in a range from 1 to 4. Examples of such monomers include CF₂═CFO(CF₂)₃OCF(CF₃)CN, perfluoro(8-cyano-5-methyl-3,6-dioxa-1-octene), and CF₂═CFO(CF₂)₅CN.

For sufficient curing of a fluoropolymer, the fluoropolymer should comprise at least 0.1, 0.5, 1, 2, or even 2.5 wt % of iodine, bromine, and/or nitrile groups versus the total weight of fluorinated polymer, depending on the composition of the polymer. In one embodiment, the fluorinated polymer comprises no more than 3, 5, or even 10 wt % of iodine, bromine, and/or nitrile groups versus the total weight of the fluorinated polymer. In one embodiment, the amorphous fluoropolymer comprises at most 0.1, 0.05, or even 0.01% by weight of iodine content as determined using techniques known in the art, such as x-ray fluorescence.

An initiator is used to initiate polymerization in the aqueous mixture. The initiator includes any of the initiators known for initiating a free radical polymerization of fluorinated monomers in aqueous solutions.

Suitable initiators include peroxides and azo compounds and redox based initiators. Specific examples of peroxide initiators include, hydrogen peroxide, sodium or barium peroxide, diacylperoxides such as diacetylperoxide, disuccinoyl peroxide, dipropionylperoxide, dibutyrylperoxide, dibenzoylperoxide, benzoylacetylperoxide, diglutaric acid peroxide and dilaurylperoxide, and further per-acids and salts thereof such as e.g. ammonium, sodium, or potassium salts. Examples of per-acids include peracetic acid. Esters of the peracid can be used as well and examples thereof include tert-butylperoxyacetate and tert-butylperoxypivalate. Examples of inorganic initiators include for example ammonium-alkali- or earth alkali salts of persulfates, permanganic or manganic acid. A persulfate initiator, e.g. potassium persulfate or ammonium persulfate (APS), can be used on its own or may be used in combination with a reducing agent. Suitable reducing agents include bisulfites such as for example ammonium bisulfite or sodium metabisulfite, thiosulfates such as for example ammonium, potassium or sodium thiosulfate, hydrazines, azodicarboxylates and azodicarboxyldiamide (ADA). Further reducing agents that may be used include sodium formaldehyde sulfoxylate (sold for example under the trade designation “RONGALIT”) or fluoroalkyl sulfinates as disclosed in U.S. Pat. No. 5,285,002 (Grootaert).

The amount of initiator may be between 0.01% by weight and 1% by weight based on the fluoropolymer solids to be produced. In one embodiment, the amount of initiator is between 0.05 and 0.5% by weight. In another embodiment, the amount may be between 0.05 and 0.3% by weight. The full amount of initiator may be added at the start of the polymerization or the initiator can be added to the polymerization in a continuous way during the polymerization. Preferably the initiator is added until a conversion of monomer to polymer of 70% to 80% is achieved. One can also add part of the initiator at the start and the remainder in one or separate additional portions during the polymerization.

The initiator can create ionic end groups. If a single initiator is used, such as a perfsulfate salt, then carbonyl-containing end groups result. If a sulfite or bisulfite reducing agent is additionally present, end groups can include sulfonic acid, sulfonates, carboxyl, and/or carboxylate end groups.

Historically, alkyl sulfinic acid and salts thereof have been used to achieve low ionic end groups during polymerization because they are efficient at generating low ionic end groups. However, it has been discovered that the sulfinates can inadvertently form alkyl monoacids and salts. Thus, in one embodiment, the aqueous mixture is substantially free (in other words less than 0.1, 0.01, or 0.001% by weight or even undetectable) of a reducing agent such as a fluorinated or nonfluorinated sulfinic acid or salt thereof.

Although perfluoromethyl iodide can achieve a low ionic end group ratio as well as reduced amounts of perfluoroalkyl monoacids in the as polymerized dispersion, in one embodiment, a perfluoroalkyl sulfinic acid or a salt thereof may be used in the polymerization to achieve an even lower ionic end group ratio in the resulting fluoropolymer, while the as polymerized dispersion may yield slightly higher amounts of perfluoroalkyl monoacids, which could be removed by further processing.

Sometimes, chain transfer agents are added during the polymerization to adjust the molecular weight of the resulting polymer and/or introduce additional cure-sites. Exemplary chain transfer agents include: dimethyl ether, methyl t-butyl ether, alkanes having 1 to 5 carbon atoms such as ethane, propane and n-pentane, halogenated hydrocarbons such as CCl₄, CHCl₃ and CH₂Cl₂; hydrofluorocarbon compounds such as CH₂F—CF₃, CF₂Br₂, Br(CF₂)₂Br, Br(CF₂)₄Br, CF₂ClBr, CF₃CFBrCF₂Br, ICF₂CF₂O(CF₂)₃OCF₂CF₂I, I(CF₂)ₙI wherein n is an integer from 1-10 (e.g., I(CF₂)₄I and I(CF₂)₃I), Br(CF₂)ₙI wherein n is an integer from 1-10 (e.g., Br(CF₂)₂I); alcohols; esters; and the like.

The typical iodinated chain transfer agents, such as I(CF₂)₄I, are solids, whereas CF₃I is a gas under standard conditions. Advantageously, it has been discovered that adding perfluoromethyl iodide during the polymerization of the aqueous mixture can result not only in a fluorinated polymer having a low acid end group ratio, but also an as polymerized aqueous dispersion having a low amount of perfluoroalkyl monoacids (such as perfluorooctanoic acid) or salts thereof. In one embodiment, at least 0.05, 0.1, 0.15, or even 0.2 wt % of perfluoromethyl iodide is added to the aqueous mixture. In one embodiment, at most 0.3, 0.4, or even 0.5 wt % of perfluoromethyl iodide is added to the aqueous mixture. The full amount of the perfluoromethyl iodide may be added at the start of the polymerization or the perfluoromethyl iodide can be added to the polymerization in a continuous way during the polymerization. One can also add part of the perfluoromethyl iodide at the start and the remainder in one or separate additional portions during the polymerization.

In one embodiment, a perfluorinated or partially fluorinated emulsifier is added to the aqueous mixture.

Exemplary fluorinated emulsifiers include those that correspond to the general formula:

[R_{f5}—O-L-COO⁻]ᵢXᵢ⁺

wherein L represents a linear or branched or cyclic partially fluorinated alkylene (alkanediyl) group or an aliphatic hydrocarbon group, R_{f5} represents a linear or branched, partially or fully fluorinated aliphatic group or a linear or branched partially or fully fluorinated group interrupted once or more than once by an ether oxygen atom, Xᵢ⁺ represents a cation having the valence i and i is 1, 2 and 3. In some embodiments, the molecular weight of the fluorinated emulsifier is less than 1500, 1000, or even 500 grams/mole. The fluorinated emulsifier may have from 4 to 19 carbon atoms, in some embodiments, from 5 to 14 or from 6 to 12 carbon atoms. Specific examples are described in, for example, U.S. Pat. Publ. No. 2007/0015937 (Hintzer et al.). Examples of such emulsifiers include: CF₃CF₂CH₂OCF₂CH₂OCF₂COOH and CF₃O(CF₂)₃OCHFCF₂COOH, CHF₂(CF₂)₅COOH. The use of one or more non-fluorinated emulsifiers, or a combination of fluorinated and non-fluorinated emulsifiers, is also possible. Examples for polymerizations of fluoropolymers with non-fluorinated emulsifiers are described, for example, in U.S. Pat. No. 7,566,762 (Otsuka et al.). The amount of emulsifier may be between 0.1% by weight and 5% by weight based on the weight of fluoropolymer to be produced. Minimizing the amount of emulsifier is desirable.

Many initiators and emulsifiers have an optimum pH-range where they show most efficiency. For this reason, buffers are sometimes useful in the aqueous mixture. Buffers include phosphate, acetate or carbonate buffers or any other acid or base, such as ammonium hydroxides. The concentration range for the buffers can vary from 0.01% to 5% by weight based on the aqueous polymerization mixture.

The aqueous mixture is polymerized to form an aqueous dispersion of a fluoropolymer. The polymerization may be run as an aqueous emulsion or aqueous suspension. The polymerizations can be a batch, semibatch, or continuous process.

In some embodiments of the method of the present disclosure, an aqueous emulsion polymerization can be carried out continuously under steady-state conditions. For example, an aqueous emulsion of monomers (e.g., including any of those described above), water, perfluoromethyl iodide, initiators, and optionally, emulsifier, and/or buffers can be fed continuously to a stirred reactor under optimum pressure and temperature conditions, while the resulting dispersion is continuously removed. In some embodiments of the method of the present disclosure, batch or semibatch polymerization is conducted by feeding the aforementioned ingredients into a stirred reactor and allowing them to react at a set temperature for a specified length of time or by charging ingredients into the reactor and feeding the monomers into the reactor to maintain a constant pressure until a desired amount of polymer is formed. After polymerization, unreacted monomers are removed from the reactor effluent latex by vaporization at reduced pressure yielding an aqueous fluoropolymer dispersion. Subsequent processing (e.g., coagulation, washing and drying) may be done on the fluoropolymer dispersion to isolate the fluoropolymer.

The polymerization is generally carried out at a temperature in a range from 10° C., and 100° C., or in a range from 30° C., and 80° C. The polymerization pressure is usually in the range of 0.3 MPa to 30 MPa, and in some embodiments in the range of 2 MPa and 20 MPa. Adjusting, for example, the concentration and activity of the initiator, the concentration of each of the reactive monomers, the temperature, and the concentration of the perfluoromethyl iodide using techniques known in the art can control the molecular weight of the resulting fluoropolymer.

Advantageously, the resulting aqueous dispersion of the method disclosed herein has low levels of perfluoroalkanoic acid, perfluoroalkane sulfonic acid, and their corresponding salts. Historically, perfluorinated octanoic acid or salts thereof were a common emulsifier. National and international regulations are trending toward the reduction in the permitted levels of these materials as detection technology advances. Thus, perfluorinated octanoic acid and other perfluoroalkyl monoacids or salts thereof are avoided as starting materials for a polymerization.

As can be seen in CE-1 shown below, although no perfluoroalkyl carboxylic acid or perfluoroalkyl sulfonic acid or their salts were used as starting materials in the polymerization, perfluoroalkyl carboxylic acid and/or perfluoroalkyl sulfonic acids were detected in the as polymerized dispersion due to side reactions. As can be seen in Ex-1 shown below, the use of perfluoromethyl iodide in the polymerization reduces the amount of C4-C14 perfluoroalkyl monoacids. Although, not wanting to be bound by theory, it is believed that the perfluoromethyl iodide forms a CF₃ and an I radical, both of which can “cap” a terminal group on one of the growing polymer ends during polymerization. In doing so, this reduces the number of terminal groups “capped” with an OH group, which eventually converts to a carboxyl group.

Although many techniques, such as ion exchange or distillation, are known to remove perfluorinated alkanoic acids or salts thereof from resulting dispersions, there is a desire to create polymerization methods, which are more sustainable. For example, balancing achieving a low ionic end group ratio while minimizing the amount of perfluoroalkyl monoacids or salts thereof formed. Achieving a polymerization wherein no perfluoroalkyl monoacids or salts thereof are present in the as polymerized dispersion is desirable.

As used herein, the perfluoroalkanoic acid or salt thereof or perfluoroalkane sulfonic acid or salt thereof (referred to herein collectively as perfluoroalkyl monoacids) can be represented by formula

F₃C—(CF₂)ₙ—Z-M

wherein n is an integer from 2 to 17, or from 6 to 12, and wherein Z represents —COO⁻ or —SO₃⁻, and M represents a cation selected from alkali metal cations (e.g., Na⁺, K⁺, etc.), ammonium ions, and H⁺. The aqueous dispersion provided by the method of the present disclosure can contain an amount of fluorinated acid or its salt of the above formula of less than 2000, 1500, 1000, 800, 600, or even 400 150 parts per billion (ppb or nanograms per gbased on the weight of the fluoropolymer). In one embodiment, the aqueous dispersion provided by the method of the present disclosure contains an amount of perfluorooctanoic acid or salt thereof of less than 25, 20, 15, or even 10 ppb. In some embodiments, the amount of perfluoroalkanoic acids having from 6 to 14 carbon atoms or salts thereof (that is, n=4 to 12 and Z represents a carboxylic acid group in formula F₃C—(CF₂)ₙ—Z-M) or perfluoroalkane sulfonic acids having from 6 to 14 carbon atoms or salts thereof in the aqueous dispersion of the fluoropolymer as polymerized is not more than 300, 250, 200, or even 100 ppb based on the weight of the fluoropolymer. In some embodiments, the amount of perfluoroalkyl carboxylic acids or salts thereof having from 6 to 14 carbon atoms or salts thereof (that is, n=4 to 12 and Z represents a carboxylic acid group in formula F₃C—(CF₂)ₙ—Z-M) in the aqueous dispersion of the fluoropolymer as polymerized is not more than 300, 250, 200, or even 100 ppb based on the weight of the fluoropolymer. In some embodiments, the amount of perfluoroalkyl sulfonic acids having 6 or 8 carbon atoms or salts thereof (that is, n=5 or 7 and Z represents a sulfinic acid group in formula F₃C—(CF₂)ₙ—Z-M) in the aqueous dispersion of the fluoropolymer as polymerized is not more than 300, 250, 200, or even 100 ppb based on the weight of the fluoropolymer.

In one embodiment, the resulting fluoropolymers made by the method disclosed herein comprise an end group represented by at least one of the following: —CF₃ or iodine and a low ratio of ionic end groups (e.g., carboxylate). By end group, is meant for purposes of this disclosure, the portion of the polymer where polymerization initiates or terminates. By low ratio, this means the amount of carbonyl-containing end groups in the fluoropolymer is less than 0.08, less than 0.05, or even less than 0.01 as determined by absorbance in Fourier Transform Infrared Spectroscopy. In some embodiments, an absorbance ratio determined by calculating the integrated peak intensity within the range of 1840 cm⁻¹-1620 cm⁻¹ to the integrated peak intensity in the range 2740 cm⁻¹-2220 cm⁻¹ in a Fourier-transform infrared spectrum of the fluoropolymer is less than 0.08, 0.07, 0.06, or 0.05. This absorbance ratio has been used in the art to indicate the level of carboxylic end groups; sec, e.g., U.S. Pat. No. 6,114,452 (Schmiegel et al.) and U.S. Pat. No. 8,604,137 (Grootaert et al.).

The method of the present disclosure can further include, in some embodiments, coagulating, washing, and drying the fluoropolymer. Any coagulant, which is commonly used for coagulation of a fluoropolymer latex may be used, and it may, for example, be an acid (e.g., nitric acid, hydrochloric acid, or sulfuric acid), which would typically lower the pH of the aqueous dispersion to 4 or below, a water-soluble organic liquid (e.g., alcohol or acetone), or a water soluble salts (e.g., calcium chloride, magnesium chloride, aluminum chloride or aluminum nitrate). In some embodiments, it may be useful to select a coagulant that does not include metal cations to provide a low level (e.g., not more than 20 ppm metal cations) in the fluoropolymer. The amount of the coagulant to be added may be in range of 0.001 to 20 parts by mass, for example, in a range of 0.01 to 10 parts by mass per 100 parts by mass of the aqueous dispersion of the fluoropolymer. Alternatively, or additionally, aqueous dispersion may be frozen for coagulation. The coagulated fluoropolymer can be collected by filtration and washed with water. The washing water may, for example, be ion exchanged water, pure water, or ultrapure water. The amount of the washing water may be from 1 to 5 times by mass to the fluoropolymer, whereby the amount of the emulsifier attached to the fluoropolymer can be reduced. Drying the fluoropolymer can then be carried out at ambient temperature or at an elevated temperature, for example, in a range from 50° C. to 150° C. or 75° C. to 125° C. Drying can be carried out at ambient pressure or reduced pressure.

The method of the present disclosure may be useful for making fluoropolymers that are also free of metal cations or comprises not more than 20 parts per million metal cations (e.g., alkaline earth metal ions, alkali metal ions, and aluminum ions). It is desirable to avoid metal cations since metal cations may be undesired impurities in many end-use applications, for example, in the electronic, semiconductor, optical, medical and pharmaceutical industries. A low content of metal cations in the composition of the present disclosure can be achieved by carrying out the polymerization in the absence of metal salt-containing initiators, emulsifiers, buffers, and coagulants.

The method of the present disclosure is useful for making amorphous fluoropolymers, in some embodiments, amophous, curable fluoropolymers. Amorphous fluoropolymers may have a glass-transition temperature (T_{g}) of less than 26° C., or less than 20° C., or less than 0° C., for example, in a range of from about −160° C., to about +19° C., from about −40° C. up to 12° C., from about −50° C. up to +15° C., or from about −55° C. up to +19° C. In some embodiments, amorphous fluoropolymers have a glass-transition temperature between −160° C., and −40° C. Amorphous fluoropolymers may have a Mooney viscosity (ML 1+10 at 121° C.) of from about 2 to about 250, 2 to about 200, from 10 to 100, or from 20 to 70.

If the amorphous fluoropolymer is perfluorinated, typically at least 50 mole percent (mol %) of its interpolymerized units are derived from TFE, optionally including HFP. The balance of the interpolymerized units of the amorphous fluoropolymer (e.g., 10 to 50 mol %) is made up of one or more perfluorinated vinyl ethers or perfluorinated allyl ethers as described above in any of their embodiments and a cure-site monomer as described above in any of its embodiments. In some embodiments, the molar ratio of units derived from TFE comonomer units to comonomer units derived from the perfluorinated vinyl ethers or perfluorinated allyl ethers described above may be, for example, from 1:1 to 4:1, wherein the unsaturated ethers may be used as single compounds or as combinations of two or more of the unsaturated ethers. Typical compositions comprise from 44-62 wt. % TFE and 38-56 wt. % PMVE and from 0.1-10 wt. % cure-site monomer and from 0-10 wt. % of other comonomers or modifiers with the amount of ingredients being selected such that the total amount is 100 wt. %.

If the amorphous fluoropolymer is not perfluorinated, it typically contains from about 5 mol % to about 90 mol % of its interpolymerized units derived from TFE, CTFE, and/or HFP; from about 5 mol % to about 90 mol % of its interpolymerized units derived from VDF, ethylene, and/or propylene; up to about 40 mol % of its interpolymerized units derived from a perfluorinated vinyl ether or perfluorinated allyl ether as described above in any their embodiments; and from about 0.1 mol % to about 5 mol %, in some embodiments from about 0.3 mol % to about 2 mol %, of a cure-site monomer. Some typical compositions comprise from about 22-30 wt % TFE, 30-38 wt % VDF. 34-42 wt % HFP and from 0.1-10 wt % cure-site monomer and from 0-10 wt. % of other comonomers or modifiers with the amount of ingredients being selected such that the total amount is 100 wt %.

Examples of amorphous fluoropolymers that can be prepared by the method of the present disclosure include a TFE/perfluoromethyl vinyl ether (PMVE) copolymer, TFE/perfluoromethyl allyl ether (PMVE) copolymer, a TFE/CF₂═CFOC₃F₇ copolymer, a TFE/CF₂═CFCF₂OC₃F₇ copolymer, a TFE/CF₂—CFOCF₃/CF₂—CFOC₃F₇ copolymer, TFE/CF₂═CFCF₂OCF₃/CF₂—CFCF₂OC₃F₇ copolymer, and a TFE/HFP copolymer. In some embodiments, the method of the present disclosure is useful for making a TFE/propylene copolymer, a TFE/propylene/VDF copolymer, a VDF/HFP copolymer, a TFE/VDF/HFP copolymer, a TFE/ethyl vinyl ether (EVE) copolymer, a TFE/butyl vinyl ether (BVE) copolymer, a TFE/EVE/BVE copolymer, a VDF/CF₂═CFOC₃F₇ copolymer, an ethylene/HFP copolymer, a CTFE/VDF copolymer, a TFE/VDF copolymer, a TFE/VDF/PMVE/ethylene copolymer, and a TFE/VDF/CF₂═CFO(CF₂)₃OCF₃ copolymer. Each of the aforementioned copolymers may also contain a monomeric unit having a cure site.

The method of the present disclosure is also useful for preparing thermoplastic fluoropolymers. The thermoplastic fluoropolymer is semi-crystalline and may have a melting point in a range from 100° C. to 340° C. In some embodiments, the semi-crystalline fluoropolymer prepared by the method of the present disclosure has a melting point of from about 250° C., to about 330° C., 286° C. to 326° C., or from 220° C. to 285° C. The semi-crystalline fluoropolymer made by the method of the present disclosure can have a melt flow index (MFI at 372° C., and 5 kg load) of 0.1-100 grams/10 minutes, in some embodiments, 0.1-60 grams/10 minutes, 0.1-50 grams/10 minutes, or 30±10 grams/10 minutes.

Suitable semi-crystalline fluorinated thermoplastic polymers made by the method of the present disclosure include those having interpolymerized units derived solely from (i) TFE, (ii) more than 5 weight percent of one or more ethylenically unsaturated copolymerizable fluorinated monomers other than TFE. Copolymers of TFE and HFP with or without other perfluorinated comonomers are known in the art as FEP's (fluorinated ethylene propylene). In some embodiments, the semi-crystalline fluorinated thermoplastic prepared by the method of the present disclosure is a copolymer of a fluorinated olefin and at least one of a fluorinated vinyl ether or fluorinated allyl ether. In some of these embodiments, the fluorinated olefin is TFE. Copolymers of TFE and perfluorinated alkyl or allyl ethers are known in the art as PFA's (perfluorinated alkoxy polymers). In these embodiments, the perfluorinated vinyl ether or perfluorinated allyl ether units are present in the copolymer in an amount in a range from 0.01 mol (mole) % to 15 mol %, in some embodiments, 0.01 mol % to 10 mol %, and in some embodiments, 0.05 mol % to 5 mol %. The perfluorinated vinyl ether or perfluorinated allyl ether may be any of those described above. In some embodiments, the semi-crystalline fluoropolymer is made by copolymerizing 30 to 70 wt % TFE, 10 to 30 wt %, HFP, and 0.2 to 50 wt % of one or more perfluorinated vinyl ethers or perfluorinated allyl ethers, including any of those described above.

In some embodiments of the method of the present disclosure the fluoropolymer is a semi-crystalline thermoplastic derived from copolymerizing 30 to 70 wt % TFE, 10 to 30 wt %, HFP, and 5 to 50 wt % of a third ethylenically unsaturated fluorinated comonomer other than TFE and HFP.

For example, such a fluoropolymer may be derived from copolymerization of a monomer charge of TFE (e.g., in an amount of 45 to 65 wt %), HFP (e.g., in an amount of 10 to 30 wt %), and VDF (e.g., in an amount of 15 to 35 wt %). Copolymers of TFE, HFP and vinylidenefluoride (VDF) are known in the art as THV. Another example of a useful semi-crystalline thermoplastic is one derived from copolymerization of a monomer charge of TFE (e.g., from 45 to 70 wt %), HFP (e.g., from 10 to 20 wt %), and an alpha olefin hydrocarbon ethylenically unsaturated comonomer having from 1 to 3 carbon atoms, such as ethylene or propylene (e.g., from 10 to 20 wt. %). Another example of a useful semi-crystalline thermoplastic is one derived from TFE and an alpha olefin hydrocarbon ethylenically unsaturated comonomer. Examples of polymers of this subclass include a copolymer of TFE and propylene and a copolymer of TFE and ethylene (known as ETFE). Such copolymers are typically derived by copolymerizing from 50 to 95 wt. %, in some embodiments, from 85 to 90 wt. %, of TFE with from 50 to 15 wt. %, in some embodiments, from 15 to 10 wt. %, of the comonomer. Still other examples of useful semi-crystalline thermoplastics include polyvinylidene fluoride (PVDF) and a VdF/TFE/CTFE including 50 to 99 mol % VdF units, 30 to 0 mol % TFE units, and 20 to 1 mol % CTFE units. Other fluoropolymers that may be prepared by the method of the present disclosure include fluoroplastics derived solely from VDF and HFP. These semi-crystalline thermoplastics typically have interpolymerized units derived from 99 to 67 weight percent of VDF and from 1 to 33 weight percent HFP, more in some embodiments, from 90 to 67 weight percent VDF and from 10 to 33 weight percent HFP.

The amorphous fluoropolymer derived from the method of the present disclosure can be blended with low molecular weight PTFE, the so-called micropowders or waxes optionally modified with HFP, and/or perfluorinated vinyl or allyl ethers, including any of those described above.

In some embodiments, the semi-crystalline fluoropolymer has at least 89% by weight of units derived from TFE and from about 0.5% to about 6%, in some embodiments, from about 0.5% to about 4% by weight of units derived from at least one perfluorinated vinyl or allyl ether comonomer such as any of those described above in any of their embodiments. In some embodiments, the semi-crystalline fluoropolymer has from 94 to 99% by weight units derived from TFE and from 1 to 5% by weight of units derived from the at least one perfluorinated vinyl or allyl ether and up to 6% by weight, or up to 4.4% by weight of units derived from HFP.

### Examples

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods. The following abbreviations are used in this section: g=grams, ng-nanograms, min=minutes, hr=hour, ° C.=degrees Celsius, and wt=weight, LC=liquid chromatography, MS=mass spectrometry, FTIR=Fourier transform infrared spectroscopy, cm=centimeters, psi=pounds per square inch, MPa=megaPascals, rpm=revolutions per minute, ppb=parts per billion. Abbreviations for materials used in this section, as well as descriptions of the materials, are provided in Table 1.

Materials Table

| Material | Details |
|---|---|
| Trifluoromethyl | Airgas, Radnor Township, PA |
| iodide (CF₃I) | |
| Perfluorobutyl | Sigma-Aldrich, Saint Louis, Missouri |
| iodide (C₄F₉I) | |

C₄-C₁₄ perfluoroalkyl carboxylic acid analysis method

The perfluoroelastomer dispersion samples were diluted 10× by weight with methanol prior to analysis by LC-MS/MS below. Mixed standard solutions containing the C₄-C₁₄ acids were prepared in methanol at concentrations ranging from approximately 2000 ng/g to 0.1 ng/g. LC/MS (Agilent 6470 Triple Quad LCMS MAID 1665) is available from, Agilent Technologies, Santa Clara, CA, United States).

### Carbonyl End Groups Analysis by FTIR

The total content of carboxyl, carboxylate, and carboxamide groups in the final polymer is determined by measuring the integrated carbonyl absorbance (i.e., the total area of all peaks in the region 1,840-1,620 cm-1) of thin polymer films using an FTIR spectrometer based on the method described in U.S. Pat. No. 8,604,137. The ionic end groups ratio was calculated from the question below. Analysis was performed using a Perkin Elmer Frontier 100 FTIR (Perkin Elmer, Waltham, Mass.).

$$Ionic end groups ratio = \frac{Carbonyl group area [ 1.84 - 1.62 {cm}^{- 2} ]}{C - \text{?} [ 2.74 - \text{?} {cm}^{- 2} ]}$$

$$\text{?} \text{indicates text missing or illegible when filed}$$

### Mooney Viscosity

Mooney viscosities can be determined in accordance with ASTM D1646-07(2012), 1 min pre-heat and a 10 min test at 121° C. (ML 1+10@121° C.).

### Example 1 (EX-1)

A 4 liter reactor was charged with 2,450 g of water, 5.2 g of ammonium persulfate (APS, (NH₄)₂S₂O₈) and 4.26 g of 28% aqueous solution of ammonium hydroxide (NH₄OH) and 58 g of a 30% aqueous solution of CF₃—O—CF₂CF₂CF₂—O—CHFCF₂—COONH₄, with 1.5% FC-70 added (based on the weight of the CF₃—O—CF₂CF₂CF₂—O—CHFCF₂—COONH₄). CF₃—O—CF₂CF₂CF₂—O—CHFCF₂—COONH₄ was prepared as described in U.S. Pat. No. 7,671,112 (Hintzer, et al.). FC-70 is a fluid commercially available from 3M Company, St Paul, Minn., under the trade designation “FLUORINERT FC-70.” The reactor was evacuated, the vacuum was broken and it was pressurized with nitrogen to 25 psi (0.17 MPa). This vacuum and pressurization were repeated three times. After removing oxygen, the reactor was heated to 72.2° C., and the vacuum was broken with perfluoromethyl vinyl ether (PMVE). The reactor was pressurized to 190 psi (1.3 MPa) with perfluoromethyl vinyl ether (PMVE) and tetrafluoroethylene (TFE). A 2.2. g (0.011 mol) of trifluoromethyl iodide (CF₃I) was injected through a charge bomb. Total precharge of PMVE and TFE was 360 g, and 112 g, respectively. The reactor was agitated at 650 rpm. As reactor pressure dropped due to monomer consumption in the polymerization reaction, PMVE and TFE were continuously fed to the reactor to maintain the pressure at 190 psi (1.3 MPa). The ratio of PMVE and TFE was 0.99 by weight was used for the polymerization. After 5 h the monomers were discontinued, and the reactor was cooled.

The resulting dispersion had a solid content of 37.0 wt. % and a pH of 2.4. The total amount of dispersion was 4,043 g. For the coagulation, the same amount of a MgCl₂/DI water solution was added to the latex. The solution contained 1.25 wt. % MgCl₂·6H₂O. The dispersion was coagulated and the solid was dried at 130° C., for 16 h. The dispersion also was used for LC/MS analysis to determine PFOA level in the dispersion.

The resulting fluoroelastomer raw gum had a Mooney viscosity of 38.3 at 121° C. The iodine content by XRF was 0.44 wt %.

### Comparative Example 1 (CE-1)

A polymer sample was prepared and tested as in EX-1 except mole equivalent amount of 3.9 g of (0.011 mol) perfluorobuthyl iodide (C₄F₉I) was used instead of trifluoromethyl iodide CF₃I.

The resulting dispersion had a solid content of 36.7 wt. % and a pH of 3.1. The total amount of dispersion was 3,986 g. For the coagulation, the same amount of a MgCl₂/DI water solution was added to the latex. The solution contained 1.25 wt. % MgCl₂·6H₂O. The dispersion was coagulated and the solid was dried at 130° C., for 16 h.

The resulting fluoroelastomer raw gum had a Mooney viscosity of 91.3 at 121° C. The iodine content by XRF was 0.4 wt %.

TABLE 1
Ionic end group ratio and C₄-C₁₄ Perfluoroalkyl monoacid

| | EX-1 | CE-1 |
|---|---|---|
| Ionic end groups ratio | 0.06 | 0.09 |
| [Carbonyl/C—F over tone] | | |

C₄-C₁₄ perfluoroalkyl monoacid (ppb)

| | | |
|---|---|---|
| C₄ | 265 | 2280 |
| C₅ | 119 | 84.0 |
| C₆ | 14.2 | 808 |
| C₇ | 30.2 | 22.3 |
| C₈ | 8.6 | 193 |
| C₉ | 43.0 | 12.6 |
| C₁₀ | 3.7 | 125 |
| C₁₁ | 31.2 | 9.6 |
| C₁₂ | 2.6 | 96.6 |
| C₁₃ | 26.7 | 7.79 |
| C₁₄ | 2.5 | 80.7 |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A method of making a fluoropolymer, the method comprising:
providing an aqueous mixture comprising a fluorinated monomer, and an initiator;
polymerizing the aqueous mixture under free radical conditions; and
adding perfluoromethyl iodide during the polymerization to provide an aqueous dispersion of the fluoropolymer,
wherein the amount of perfluorooctanoic acid or salt thereof in the aqueous dispersion of the fluoropolymer is not more than 25 nanograms per gram of the fluoropolymer and the fluoropolymer has a Mooney viscosity (ML 1+10 at 121° C.) of from 10 to 100.

2. The method of claim 1, wherein the amorphous fluoropolymer has an end group comprising at least one of —CF₃, or iodine, and wherein an absorbance ratio determined by calculating the integrated peak intensity within the range of 1840 cm⁻¹-1620 cm⁻¹ to the integrated peak intensity in the range 2740 cm⁻¹-2220 cm⁻¹ in a Fourier-transform infrared spectrum of the fluoropolymer is less than 0.08.

3. The method of claim 1, wherein the amount of perfluoroalkanoic acids having from 6 to 14 carbon atoms or salts thereof in the aqueous dispersion of the fluoropolymer as polymerized is not more than 150 nanograms per gram of the fluoropolymer.

4. The method of claim 1, wherein the fluorinated monomer comprises at least one of tetrafluoroethylene, hexafluoropropylene, vinylidene fluoride, and perfluorinated ether.

5. The method of claim 4, wherein the perfluorinated ether is at least one of perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), CF₂═CF(OCF₂CF(CF₃))₂—O—C₃F₇ (PPVE-3), CF₂═CF(OCF₂CF(CF₃))₃—O—C₃F₇ (PPVE-4,) perfluoro-3-methoxy-n-propylvinyl ether, perfluoro-2-methoxy-ethylvinyl ether, perfluoro-methoxy-methylvinylether (CF₃—O—CF₂—O—CF—CF₂), CF₃—(CF₂)₂—O—CF(CF₃)—CF₂—O—CF(CF₃)—CF₂—O—CF—CF₂, perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, CF₃—(CF₂)₂—O—CF(CF₃)—CF₂—O—CF(CF₃)—CF₂—O—CF₂CF═CF, and mixtures thereof.

6. The method of claim 1, wherein the aqueous mixture further comprises a cure-site monomer, wherein the cure-site monomer comprises at least one of a bromo-, iodo-, or nitrile-cure site.

7. The method of claim 6, wherein the cure-site monomer comprises a perfluoro-[6-iodo-4-oxa-hexyl-vinyl] ether, CF₂═CFO(CF₂)₅CN, or combinations thereof.

8. The method of claim 1, wherein the fluoropolymer is perfluorinated.

9. The method of claim 1, wherein the fluoropolymer is partially fluorinated.

10. The method of claim 1, wherein the aqueous mixture further comprises an emulsifier.

11. The method of claim 1, wherein the fluoropolymer is amorphous.

12. The method of claim 1, wherein the fluoropolymer is semi-crystalline.

13. The method of claim 1, wherein the method is substantially free of an alkyl sulfinic acid or salt thereof.

14. The method of claim 1, further comprising coagulating the fluoropolymer and optionally drying the fluoropolymer.

15. A fluoropolymer made by the method of claim 1.
